(19) United States
(12) Patent Application Publication
(10) Pub. No.: US 2004/0110532 A1
(43) Pub. Date: Jun. 10, 2004

(54) Telephone control method for portable information processing terminal and telephone control program product

(76) Inventors: Ryouichi Ochi, Kanagawa (JP); Yoshikazu Kobayashi, Kanagawa (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/724,216

(22) Filed: Dec. 1, 2003

(30) Foreign Application Priority Data
Dec. 2, 2002 (JP) 2002-350063

(51) Int. Cl. H04B 1/38; H04M 1/00

(52) U.S. Cl. 455/556.2; 455/556.1

(57) ABSTRACT

CPU (Information Processing Unit) of PDA extracts prescribed hardware information such as mounting/demounting of a cradle from hardware information, and carries out telephone operation control such as on-hook, off-hook, etc. on the basis of the hardware information thus extracted. CPU of PDA extracts prescribed hardware information (turn-on state of back light of a display portion) from hardware information, and a hardware controller 2 carries out turn-on control of back light or the like of the display portion on the basis of the extracted hardware information and telephone control information such as information indicating whether a telephone call state of PDA is possible or not.

### BACKGROUND OF THE INVENTION

1. Field of the Invention

The present invention relates to a telephone control method for a portable information processing terminal and a telephone control program product.

2. Description of the Related Art

Telephone terminal applications using Personal Digital Assistance (PDA) have been unsatisfied in their functions because the resource of PDA does not sufficiently abound. Particularly, there is such a disadvantage that the telephone time is restricted by insufficient battery and voice (sound) quality is restricted due to limitations in CPU performance and memory capacity. PDA has such a feature that it is liable to consume CPU or memory capacity because many applications thereof stay at all times once they are started. In addition, the operation thereof is hardly linked to a human's intuitive operation because it is required to make an indication on a screen by using a stylus or the like.

### SUMMARY OF THE INVENTION

The present invention has been implemented in view of the foregoing situation, and has an object to provide a Personal Digital Assistance (PDA) phone that can control the operation of the resource and hardware of PDA on the basis of a call state of the PDA Phone, mainly, telephone terminal software for making communications with Internet Protocol (IP) such as Real-time Transport Protocol (RTP), Hyper Text Transport Protocol (HTTP) or the like by using a portable information processing terminal such as PDA or the like, and/or control the call state on the basis of the operation of the resource and hardware.

In order to attain the above object, according to a first aspect of the present invention, there is provided a telephone control method for a portable information processing terminal, which comprises extracting prescribed hardware information from hardware information of the portable information processing terminal by an information processor of the portable information processing terminal, and performing telephone operation control on the basis of the hardware information thus extracted.

Furthermore, according to a second aspect of the present invention, there is provided a telephone control method for a portable information processing terminal, which comprises extracting prescribed hardware information from hardware information of the portable information processing terminal by an information processor of the portable information processing terminal, and controlling prescribed hardware associated with the prescribed hardware information on the basis of the hardware information thus extracted and telephone control information of the portable information processing terminal.

According to a third aspect of the present invention, there is provided a telephone control program product for a portable information processing terminal, which comprises a first step of extracting prescribed hardware information from hardware information of the portable information processing terminal by an information processor of the portable information processing terminal, and a second step of comparing the prescribed hardware information thus extracted with the recorded telephone operation processing corresponding to the hardware information of the portable information processing terminal, and carrying out the telephone operation control corresponding to the prescribed hardware information by the information processor.

According to a fourth aspect of the present invention, there is provided a telephone control program product for a portable information processing terminal, which comprises a first step of extracting prescribed hardware information from hardware information of the portable information processing terminal by an information processor of the portable information processing terminal, and a second step of comparing the hardware information thus extracted and the telephone control information of the portable information processing terminal with the recorded control information associated with the hardware corresponding to the telephone control information of the portable information processing terminal, and carrying out the control of the hardware corresponding to the telephone control information of the portable information processing terminal.

### BRIEF DESCRIPTION OF THE DRAWINGS

FIG. 1 is a diagram showing a process flow of an embodiment of a telephone control method for a portable information processing terminal and a telephone control program product according to the present invention;

FIG. 2 is a block diagram showing the hardware construction of a portable information processing terminal having a telephone terminal application to which the present invention is applied;

FIG. 3 is a block diagram showing a portable information processing terminal using another embodiment of a telephone control method for a portable information processing terminal and a telephone control program product according to the present invention; and

FIG. 4 is a block diagram showing an example of the hardware construction of a portable information processing terminal according to a second embodiment or third embodiment.

### DETAILED DESCRIPTION OF THE PREFERRED EMBODIMENTS

Preferred modes of embodiment according to the present invention will be described hereunder with reference to the accompanying drawings.

[First Embodiment]

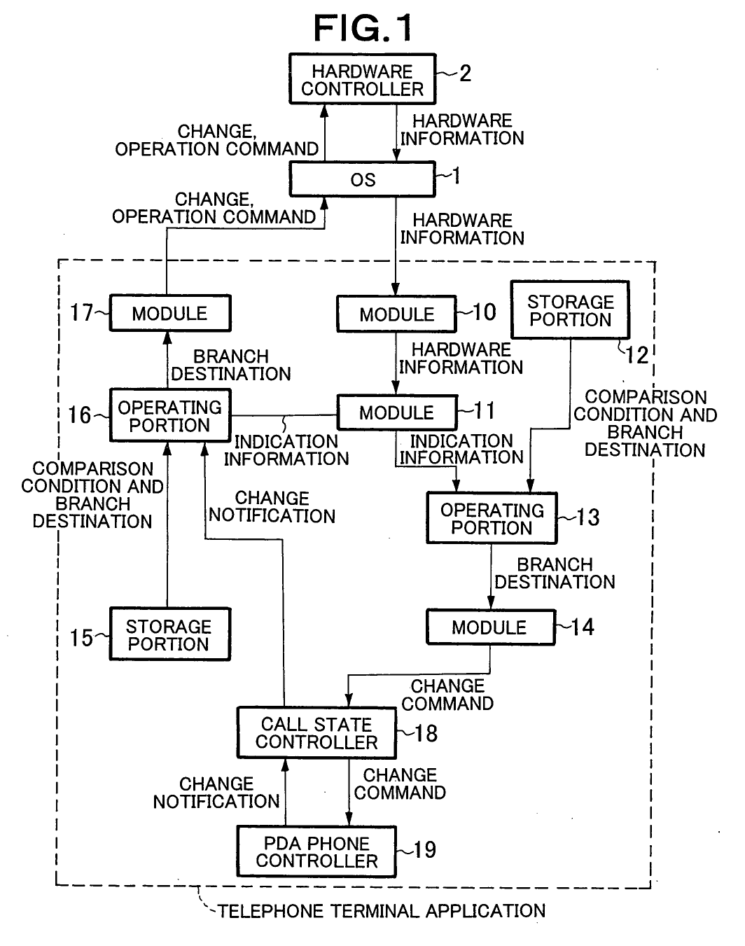

FIG. 1 is a diagram showing the process flow of an embodiment of a telephone control method for a portable information processing terminal and a telephone control program product according to the present invention.

As shown in FIG. 1, a telephone terminal application is provided for OS portion 1 and hardware controller 2 such as a driver (device driver), etc. of PDA (Personal Digital Assistances).

The telephone terminal application comprises module 10 for outputting a command for requesting information on resource and hardware to the OS portion 1, module 11 for receiving and analyzing the information achieved by the module 10 to pick up necessary information, storage portion 12 for storing a comparison condition for the resource and hardware information and the processing of changing a call state to be selected when fitted to the comparison condition, operating portion 13 for receiving the information of the module 11 and comparing the information with the comparison condition of the storage portion 12, thereby determining the processing to be selected, module 14 for receiving the result of the operating portion 13 and commanding a change to the call state, storage portion 15 for storing a comparison condition for the resource and hardware and the call state, and the processing of changing the resource and hardware to be selected when fitted to the comparison condition, operating portion 16 for receiving the output of the module 11 and a change notification from the call state controller 18, and comparing them with the comparison condition of the storage portion 15, thereby determining the processing to be selected, module 17 for receiving the result of the operating portion 16 and commanding the OS portion 1 to change the resource and hardware, PDA phone call state controller 18, and PDA Phone controller 19.

Any one of a group containing the storage portion 12, the operating portion 13 and the module 14 and a group containing the storage portion 15, the operating portion 16 and the module 17 may be eliminated.

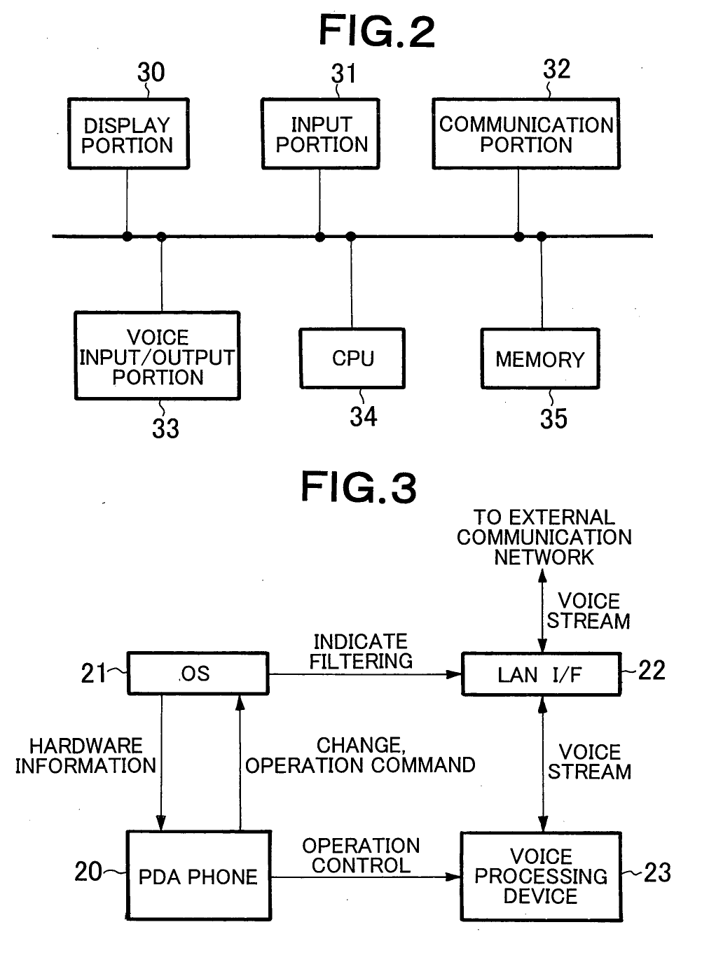

FIG. 2 is a block diagram showing an example of the hardware construction of a portable information processing terminal such as PDA equipped with a telephone terminal application to which the present invention is applied.

The portable information processing terminal comprises display portion 30 such as a liquid crystal panel, an EL panel or the like, input portion 31 such as a button operating portion, a keyboard or the like, communication portion 32 such as an antenna, a transceiver or the like, voice input/output portion 33 for carrying out a telephone operation, CPU (Information Processing Unit) 34 for executing applications such as OS, a telephone terminal application, etc., and memory 35 such as ROM, RAM or the like for storing the applications such as OS, the telephone terminal application, etc. and various kinds of data.

The input portion 31 also serves as a display portion when it is an input touch panel using a dedicated pen or the like. The communication portion 32 may be constructed so to be insertable into the portable information terminal in the form of a wireless communication card such as a wireless LAN card, a Personal Handy-phone System (PHS) card or the like.

The module 10 requests resource and hardware information to the OS portion 1 every constant time or at a required timing. Since the OS portion 1 holds the resource and hardware information from the hardware controller 2, it returns the information on the resource and hardware to the module 10. The information achieved by the module 10 is processed by the module 11 to achieve only necessary information. The storage portion 12 stores comparison information such as information as to whether the PDA concerned is currently mounted in a cradle and branch destination information such as information as to how is a call state treated when the PDA concerned is mounted in the cradle. The operating portion 13 compares the comparison information and branch destination information with the information achieved from the module 11 to settle a destination to which the state is shifted. The module 14 sends the result to the call state controller 18, and finally a command for changing the operation is transmitted to the PDA Phone controller 19. This is the procedure of changing the operation of PDA Phone on the basis of the operation result of the resource and hardware.

On the other hand, when the call state of PDA Phone is changed by the telephone call made from the external and thus the change of the call state is transmitted from the PDA Phone controller 19 to the call state controller 18, a change notification from the call state controller 18 and a monitor result from the module 11 are compared with the resource and hardware state and the comparison condition for the call state in the storage portion 15 by the operating portion 16 to select the operation command to the resource and hardware. This command is transmitted to the OS portion 1 by the module 17, and the OS portion 1 controls the operation of the hardware controller 2. This is the procedure of controlling the resource and hardware from the change of the call state.

According to this embodiment, the comfortable level under use of the telephone application can be enhanced by controlling the operation of the resource and hardware on the basis of the change of the call state and also controlling the call state on the basis of the operation of the resource and hardware.

[Second Embodiment]

According to the second embodiment, a connection state of a cradle is achieved from hardware information, and an off-hook operation is controlled on the basis of the connection state thus achieved.

The construction of the telephone terminal application is identical to the construction shown in FIG. 1 or identical to the construction shown in FIG. 1 except that the storage 15, the operating portion 16 and the module 17 are eliminated.

As shown in FIG. 1, the module 11 achieves the connection state of the cradle on the basis of the hardware information achieved from the OS portion 1 by the module 10. The storage portion 12 contains condition information and branch information as to what the off-hook operation is carried out if PDA is demounted from the cradle. These information are compared in the operating portion 13. If it is judged through this operation that the off-hook operation should be carried out, the module 14 transmits a command to the call state controller 18 to carry out the off-hook operation, and the off-hook operation of PDA Phone is carried out. An off-hook for emitting a call and an off-hook for responding to call reception can be set to be selectable.

In this embodiment, the off-hook operation of PDA Phone can be carried out by demounting the PDA from the cradle.

[Third Embodiment]

According to this embodiment, the connection state of the cradle is achieved from the hardware information, and the on-hook operation is controlled on the basis of the connection state of the cradle.

The construction of the telephone terminal application is identical to the construction shown in FIG. 1, or identical to the construction shown in FIG. 1 except that the storage portion 15, the operating portion 16 and the module 17 are eliminated.

As shown in FIG. 1, the module 11 achieves the connection state of the cradle on the basis of the hardware information achieved from the OS portion 1 by the module 10. The storage portion 12 contains condition information and branch information as to what the on-hook operation is carried out if PDA is connected to the cradle. These information are compared in the operating portion 13. If it is judged through this operation that the on-hook operation should be carried out, the module 14 transmits a command to the call state controller 18 to carry out the on-hook operation, and the on-hook operation of PDA Phone is carried out.

In this embodiment, the on-hook operation of PDA Phone can be carried out by connecting PDA to the cradle.

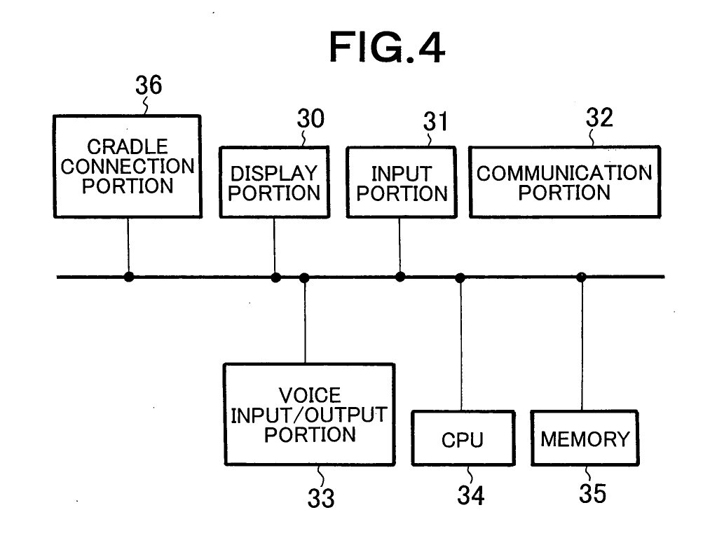

FIG. 4 is a block diagram showing an example of the hardware construction of the portable information processing terminal according to the second or third embodiment. The same constituent parts as shown in FIG. 2 are represented by the same reference numerals, and the description thereof is omitted.

The portable information processing terminal of the second or third embodiment has cradle connecting portion 36, and the cradle connection portion 36 is equipped with a mechanism such as a switch for detecting whether PDA serving as the portable information processing terminal is mounted in or demounted from the cradle, or with a detection mechanism for current or voltage detection based on connector connection, or detection based on infrared ray or the like. Accordingly, a detection signal from the mechanism such as the switch or the like or a detection signal from the detection mechanism such as the current or voltage detection based on the connector connection is transmitted as hardware information to the memory 35. The control of the cradle connection portion 36 is carried out by the hardware controller 2 shown in FIG. 1, and the OS portion 1 transmits this hardware information to the telephone terminal application shown in FIG. 1.

[Fourth Embodiment]

According to this embodiment, a back light or front light equipped to the display portion 30 is controlled to be turned off on the basis of the communication state.

The construction of the telephone terminal application is identical to that shown in FIG. 1 or identical to that shown in FIG. 1 except that the storage portion 12, the operating portion 13 and the module 14 are eliminated.

As shown in FIG. 1, the module 11 achieves the light amount state of the back light or front light on the basis of the hardware information achieved from the OS portion 1 by the module 10. The light amount of the back light or front light of the display portion 30 is controlled by the hardware controller 2, and the light amount state is transmitted as hardware information to the module 10 by the OS portion 1. The storage portion 15 stores condition information and branch information indicating that if the call state is set to a telephone call and the light amount of the back light or front light is not equal to zero, the back light or front light is set to zero. When it is notified, from the PDA Phone controller 19 to the call state controller 18, that the call state is set to the telephone call state, the operating portion 16 compares the notification from the call state controller 18 and the information achieved from the module 11 with the condition stored in the storage portion 15. When a result indicating that the light amount is set to zero is output, the module 17 transmits a command to the OS portion 1 so that the OS portion 1 carries out the operation of setting the light amount of the back light or front light on the screen to zero, and thus the operation of setting the light amount of the back light or front light to zero is carried out.

In this embodiment, the back light or front light is turned out during telephone call of PDA Phone, thereby suppressing reduction in battery power.

[Fifth Embodiment]

According to this embodiment, the back light or front light equipped to the display portion 30 is controlled to be set to its original turn-on state on the telephone call state.

The construction of the telephone terminal application is identical to the construction shown in FIG. 1, or identical to the construction shown in FIG. 1 except that the storage portion 12, the operating portion 13 and the module 14 are eliminated.

As shown in FIG. 1, the storage portion 15 is further added with condition information and branch information indicating that when the telephone call state is finished, the light amount of back light or front light is returned to its original setting value. When the telephone call is finished, the operating portion 16 compares the notification from the call state controller 18 with the content of the storage portion 15. As a result, it is required to return the light amount to the original set value, the module 17 transmits a command to the OS portion 1 so that the back light or front light on the screen is returned to the original set value, and thus the light amount of the back light or front light is returned to the original set value.

In this embodiment, the turn-off of the back light or front light during telephone call is released at the time when the telephone call is finished.

In the fourth and fifth embodiments, the control of the light amount of the back light or front light used for the liquid crystal display panel or the like has been described. However, the above embodiments are applicable to a case where a self-luminous element such as an EL panel or the like is used as the display portion.

[Sixth Embodiment]

According to this embodiment, a specific application is controlled to be finished on the basis of the telephone call state.

The construction of the telephone terminal application is identical to the construction shown in FIG. 1, or identical to the construction shown in FIG. 1 except that the storage portion 12, the operating portion 13 and the module 14 are eliminated.

As shown in FIG. 1, the module 11 picks up and notifies a list of applications being currently operated from the information achieved from the OS portion 1 by the module 10. The storage portion 15 stores condition information and branch information indicating that if the call state is set to a telephone call state, some specific applications are finished. When the call state is set to the telephone call (when there is a calling notification), the operating portion 16 compares the notification from the call state controller 18 and the notification from the module 11 with the condition of the storage portion 15, and as a result if it is required to finish a specific application, the module 17 transmits a command to the OS portion 1 so as to finish the specific application. Therefore, the specific application concerned is finished.

The memory and the CPU resource can be secured by finishing some specific applications before the PDA Phone is set to a telephone call state. It is expected that the effect can be more enhanced by indicating an application using a large memory capacity or the same input/output device as PDA Phone as an application to be finished.

[Seventh Embodiment]

FIG. 3 is a block diagram showing a portable information processing terminal using another embodiment of the telephone control method for the portable information processing terminal and the telephone control program product according to the present invention.

As shown in FIG. 3, the portable terminal information terminal of this embodiment has PDA Phone 20 having the construction of the telephone terminal application of FIG. 1 for the OS portion 21, LAN I/F (Interface) 22 for the OS portion 21 and voice processing device 23 having a voice processing capability.

When PDA Phone 20 is set to a telephone call state, a command is transmitted to the OS portion 21. This command instructs the LAN I/F 22 to subject data achieved as a voice stream to filtering and then transmit the data thus filtered to the voice processing device 23. The voice processing device 23 processes the voice data which are achieved by using its processing capability. PDA Phone 20 may transmit a control command to the voice processing device 23 as occasion demands.

When PDA Phone 20 is used, voice processing can be performed without using the CPU processing capability of the PDA itself.

[Eighth Embodiment]

This embodiment relates to a portable information processing terminal when the LAN I/F 22 and the voice processing device 23 are provided as a single hardware module.

Even when there is no command from the PDA Phone 20 to the OS portion 21 in the seventh embodiment, the LAN I/F 22 can subject a received voice stream to filtering and then transmit it to the voice processing device 23.

In this embodiment, the load of PDA Phone on CPU of PDA can be further reduced.

Obviously many modifications and variations of the present invention are possible in light of the above teaching. It is therefore to be understood that within the scope of the appended claims in the invention may be practiced otherwise than as specifically described.

What is claimed is:

1. A telephone control method for a portable information processing terminal, which comprises extracting prescribed hardware information from hardware information of said portable information processing terminal by an information processor of said portable information processing terminal, and performing telephone operation control on the basis of the hardware information thus extracted.

2. A telephone control method for a portable information processing terminal, which comprises extracting prescribed hardware information from hardware information of said portable information processing terminal by an information processor of said portable information processing terminal, and controlling prescribed hardware associated with the prescribed hardware information on the basis of the hardware information thus extracted and telephone control information of said portable information processing terminal.

3. The telephone control method according to claim 1, wherein the hardware information thus extracted is information on mounting/demounting of a cradle of said portable information processing terminal, and the telephone operation control is an off-hook operation or on-hook operation.

4. The telephone control method according to claim 2, wherein the hardware information thus extracted is a light amount state of a display portion of said portable information processing terminal, the telephone control information is information indicating whether a telephone call state is possible or not, and the control of the prescribed hardware is a light amount control of the display portion.

5. The telephone control method according to claim 2, wherein the hardware information thus extracted is a list of applications being operated of said portable information processing terminal, the telephone control information is a call notification, and the control of the prescribed hardware is a control of finishing at least one application.

6. The telephone control method according to claim 2, wherein said portable information processing terminal has a voice processing device, the hardware information thus extracted indicates the state of the voice processing device, the telephone control information indicates whether a telephone call state is possible or not, and the control of the prescribed hardware is a control for transmitting voice data to the voice processing device.

7. A telephone control program product embodied on a storage portion of a portable information processing terminal and comprising code that, when said program product executed, cause said portable information processing terminal to perform a telephone control method comprising:
a first step of extracting prescribed hardware information from hardware information of said portable information processing terminal by an information processor of said portable information processing terminal, and
a second step of comparing the prescribed hardware information thus extracted with the recorded telephone operation processing corresponding to the hardware information of said portable information processing terminal, and carrying out the telephone operation control corresponding to the prescribed hardware information by the information processor.

8. A telephone control program product embodied on a storage portion of a portable information processing terminal and comprising code that, when said program product executed, cause said portable information processing terminal to perform a telephone control method comprising:
a first step of extracting prescribed hardware information from hardware information of said portable information processing terminal by an information processor of said portable information processing terminal, and
a second step of comparing the hardware information thus extracted and the telephone control information of said portable information processing terminal with the recorded control information associated with the hardware corresponding to the telephone control information of said portable information processing terminal, and carrying out the control of the hardware corresponding to the telephone control information of said portable information processing terminal.
